(19) United States
(12) Patent Application Publication
(10) Pub. No.: US 2014/0218657 A1
(43) Pub. Date: Aug. 7, 2014

(54) CONTROL CIRCUIT FOR LIGHT EMITTING APPARATUS

(71) Applicant: ROHM CO., LTD., Ukyo-Ku (JP)

(72) Inventors: Shingo HARUTA, Ukyo-Ku (JP); Shunsuke SAITO, Ukyo-Ku (JP); Hiroki KIKUCHI, Ukyo-Ku (JP); Yoshikazu SASAKI, Ukyo-Ku (JP)

(73) Assignee: ROHM CO., LTD., Ukyo-Ku (JP)

(21) Appl. No.: 14/085,159

(22) Filed: Nov. 20, 2013

(30) Foreign Application Priority Data
Nov. 20, 2012 (JP) 2012-254504

(51) Int. Cl. G09G 3/34

(52) U.S. Cl. CPC G09G 3/3406
USPC 349/61; 315/224

(57) ABSTRACT

An error amplifier amplifies the difference between a first detection voltage V_{R} at a first detection resistor on a path of a driving current I_{LED} and a dimming control signal V_{DIM} that corresponds to the target luminance level of a light emitting element. A pulse width modulator generates a gate pulse signal according to an output V_{FB} of the error amplifier. M comparators each assert an overcurrent detection signal when a corresponding detection voltages V_{R1} or V_{R2} that corresponds to voltage drop across detection resistors R1 or R2 exceeds a corresponding threshold voltage V_{TH1} or V_{TH2}. Of the threshold voltages V_{TH1} and V_{TH2}, at least one is set (i) to increase as the dimming control signal V_{DIM} increases when the dimming control signal V_{DIM} exceeds a predetermined first value, and (ii) to a predetermined lower limit value when the dimming control signal V_{DIM} is lower than the first value.

### BACKGROUND OF THE INVENTION

1. Field of the Invention

The present invention relates to a driving technique for a light emitting element.

2. Description of the Related Art

In recent years, as a backlight of a liquid crystal panel or as an illumination device, a light emitting apparatus is employed, which is configured using a light emitting element such as an LED (light emitting diode) or the like. FIG. 1 is a circuit diagram showing an example configuration of a light emitting apparatus according to a comparison technique. The light emitting apparatus 1003 includes a light emitting element 6 and a switching power supply 1004.

The light emitting element 6 is an LED string including multiple LEDs connected in series. The switching power supply 1004 steps up an input voltage V_{IN} input via its input terminal P1, and supplies a driving voltage V_{OUT} to one end of the light emitting element 6 connected to its output terminal P2.

The switching power supply 1004 includes an output circuit 102 and a control IC 1100. The output circuit 102 includes an inductor L1, a switching transistor M1, a rectifier diode D1, and an output capacitor C1. The control IC 1100 controls the on/off duty ratio of the switching transistor M1, so as to adjust the driving voltage V_{OUT}.

A PWM dimming switch (transistor) M2 and a detection resistor R1 for detecting a current are arranged on a path of a driving current I_{LED} that flows through the light emitting element 6. The controller 1010 generates a pulse signal G1 used for the PWM dimming control operation and having a duty ratio which is adjusted according to the target luminance level. A driver DR2 switches on and off the PWM dimming switch M2 according to the pulse signal G1.

A voltage drop (detection voltage) V_{R1} across the detection resistor R1 is proportional to the driving current I_{LED} that flows through the light emitting element 6. An error amplifier EA1 amplifies the difference between the detection voltage V_{R1} and a control voltage V_{REF}, so as to generate a feedback voltage V_{FB}. The controller 1010 generates a gate pulse signal G2 pulse width modulated according to the feedback voltage V_{FB}. A driver DR1 switches on and off the switching transistor M1 according to the gate pulse signal G2.

With such a configuration described above, a feedback control operation is performed such that the driving current I_{LED} approaches the target value V_{REF}/R1. Thus, such an arrangement allows the light emitting element 6 to emit light at a luminance level that corresponds to the control voltage V_{REF} Related techniques have been disclosed in Japanese Patent Application Laid Open No. 2009-261158, for example.

The light emitting apparatus 1003 performs overcurrent detection in order to protect its circuit elements. A comparator CMP1 compares the detection voltage V_{R1} with a predetermined threshold voltage V_{TH1}. When V_{R1} is higher than V_{TH1}, i.e., when the driving current I_{LED} exceeds a predetermined threshold value the comparator CMP1 asserts (sets to high level) an overcurrent detection signal OCP1. When the overcurrent detection signal OCP1 is asserted, the controller 1010 switches the gate pulse signal G2 to low level, so as to turn off the switching transistor M1.

Furthermore, a detection resistor R2 is arranged on a path of a current that flows through the switching transistor M1. A voltage drop (detection voltage V_{R2}) across the detection resistor R2 is proportional to the current I_{L1} that flows through the inductor L1. A comparator CMP2 compares the detection voltage V_{R2} with a predetermined threshold voltage V_{TH2}. When V_{R2} becomes higher than V_{TH2}, i.e., when the coil current I_{L} exceeds a predetermined threshold value I_{TH2} the comparator CMP2 asserts an overcurrent detection signal OCP2. When the overcurrent detection signal OCP2 is asserted, the controller 1010 switches the gate pulse signal G2 to low level, so as to turn off the switching transistor M1.

With conventional techniques, the threshold voltages V_{TH1}, and V_{TH2} are determined based on the maximum rated current values set for the inductor L1, the rectifier diode D1, the light emitting element 6, the switching transistor M1, the PWM dimming switch M2, and the like. Furthermore, the threshold voltages V_{TH1} and V_{TH2} are each fixed to a constant value regardless of the magnitude of the driving current I_{LED}.

### SUMMARY OF THE INVENTION

The present inventor has investigated such a light emitting apparatus 1003, and has come to recognize the following problem. With conventional circuits, overcurrent detection is performed simply in order to protect the circuit elements. Thus, such conventional circuits allow a large current to flow through the circuit elements as long as the large current does not exceed the maximum rated current. That is to say, in this state, unnecessary wasted current can flow through the circuit. Thus, there is room for reducing power consumption.

The present invention has been made in order to solve such a problem. Accordingly, it is an exemplary purpose of an embodiment of the present invention to provide a control circuit having both an advantage of reduced power consumption and an advantage of protecting the circuit in a sure manner.

An embodiment of the present invention relates to a control circuit used for a light emitting apparatus. The light emitting apparatus comprises a light emitting element and a switching power supply configured to supply a driving voltage to one end of the light emitting element. The control circuit is configured to control a switching transistor of the switching power supply, and to perform switching of a driving current that flows through the light emitting element. The control circuit comprises: a first detection resistor arranged on a path of the driving current; an error amplifier configured to amplify the difference between a first detection voltage that corresponds to a voltage drop across the first detection resistor and a dimming control signal having a level that corresponds to a target luminance level of the light emitting element, so as to generate a feedback voltage; a pulse modulator configured to generate a gate pulse signal having a duty ratio adjusted according to the feedback voltage; M (M represents an integer) detection resistors each provided to a current path of the light emitting apparatus that is to be a target of overcurrent protection; a voltage source configured to generate M threshold voltages that correspond to the respective M detection resistors; and M comparators provided for the respective detection resistors, each of which is configured to assert an overcurrent detection signal when a detection voltage that corresponds to a voltage drop across the corresponding detection resistor exceeds a corresponding threshold voltage. At least one from among the M threshold voltages is set (i) such that it is increased according to an increase in the dimming control signal in a range in which the dimming control signal is higher than a predetermined first value, and (ii) such that it is set to a predetermined lower limit value in a range in which the dimming control signal is lower than the first value.

With the resistance value of the first detection resistor as R1, and with the dimming control signal as V_{DIM}, the driving current I_{LED} is stabilized to the target value (V_{DIM}/R1), which is proportional to the dimming control signal V_{DIM}.

Directing attention to the detection resistor Ri through which a given current Ii flows, when the detection voltage V_{Ri} that corresponds to a voltage drop across the detection resistor Ri exceeds the corresponding threshold voltage V_{THi}, i.e., when the current Ii that flows through the detection resistor Ri exceeds the threshold current I_{THi} (=V_{THi}/Ri), it is judged to be an overcurrent state.

In the normal state, the current Ii that flows through a path of the light emitting element to be a target of overcurrent protection changes according to the target level of the driving current I_{LED}. That is to say, as the target level of the driving current I_{LED} becomes higher, the current Ii that flows through the path becomes greater. As the target level of the driving current I_{LED} becomes lower, the current Ii that flows through the path becomes smaller.

With such an embodiment, in a range in which the dimming control signal V_{DIM} is higher than the first value, the threshold value I_{THi} for overcurrent detection is changed according to the target value of the driving current I_{LED}. Thus, such an arrangement ensures the protection of the circuit. Furthermore, when the target value of the driving current I_{LED} is small, such an arrangement reduces the threshold current I_{THi} so as to suppress an increase in unnecessary wasted current Ii, thereby providing reduced power consumption.

Moreover, in a range in which the dimming control signal V_{DIM} is lower than the first level, the driving current I_{LED} is small, and accordingly, the current Ii is also small. This leads to a reduced voltage drop V_{Ri} across the detection resistor Ri, resulting in increased probability of false detection of the overcurrent state due to noise. In order to solve such a problem, in such a range in which the dimming control signal V_{DIM} is lower than the first value, the threshold voltage V_{THi} is clamped at a predetermined lower level, thereby preventing false detection of the overcurrent state due to noise.

Also, at least one from among the M threshold voltages may be set (i-1) such that it is increased according to the dimming control signal in a range in which the dimming control signal is higher than the first value and is lower than the second value, and (i-2) such that it is set to a predetermined upper limit value in a range in which the dimming control signal is higher than the second value.

If the threshold voltage V_{THi} is raised according to an increase in the target value of the driving current I_{LED} without limitation, when the target value is set to an extremely large value, such an arrangement does not prevent an extremely large current from flowing through a path to be protected. With the present embodiment, in a range in which the dimming control signal V_{DIM} is higher than the second value, the threshold voltage V_{THi}, i.e., the threshold current I_{THi}, is clamped at a predetermined upper limit level. Thus, such an arrangement limits the current such that it does not exceed the predetermined upper limit level. As a result, such an arrangement facilitates the selection of the components of the circuit.

Also, one of the aforementioned M detection resistors may correspond to the aforementioned first detection resistor. Such an arrangement is capable of detecting the overcurrent state of the driving current based on the first detection voltage.

Also, one of the aforementioned M detection resistors may correspond to the second detection resistor arranged on a path of the switching transistor. Based on the second detection voltage, such an arrangement is capable of protecting the circuit from the overcurrent state of the current that flows through the switching transistor and the inductor in the on period of the switching transistor.

Also, one of the aforementioned M detection resistors may correspond to the aforementioned first detection resistor. Also, another one of the aforementioned M detection resistors may correspond to the second detection resistor arranged on a path of the switching transistor.

Another embodiment of the present invention relates to a control circuit used for a light emitting apparatus. The light emitting apparatus comprises a light emitting element and a switching power supply configured to supply a driving voltage to one end of the light emitting element. The control circuit is configured to control a switching transistor of the switching power supply, and to perform switching of a driving current that flows through the light emitting element. The control circuit comprises: a current driver configured to generate a driving current according to a dimming control signal having a level that corresponds to a target luminance level of the light emitting element, and to supply the driving current thus generated to the light emitting element; an error amplifier configured to amplify the difference between a voltage drop across the current driver and a predetermined reference voltage, so as to generate a feedback voltage; a pulse modulator configured to generate a gate pulse signal having a duty ratio adjusted according to the feedback voltage; M (M represents an integer) detection resistors, each provided to a current path of the light emitting apparatus that is to be a target of overcurrent protection; a voltage source configured to generate M threshold voltages that correspond to the respective M detection resistors; and M comparators provided to the respective detection resistors, each of which is configured to assert an overcurrent detection signal when a detection voltage that corresponds to a voltage drop across the corresponding detection resistor exceeds a corresponding threshold voltage. At least one from among the M threshold voltages is set (i) such that it is increased according to an increase in the dimming control signal in a range in which the dimming control signal is higher than a predetermined first value, and (ii) such that it is set to a predetermined lower limit value in a range in which the dimming control signal is lower than the first value.

With such an embodiment, in a range in which the dimming control signal V_{DIM} is higher than the first value, the threshold value I_{THi} for overcurrent detection is changed according to the target value of the driving current I_{LED}. Thus, such an arrangement ensures the protection of the circuit. Furthermore, when the target value of the driving current I_{LED} is small, such an arrangement reduces the threshold current I_{THi} so as to suppress an increase in unnecessary wasted current Ii, thereby providing reduced power consumption.

Moreover, in a range in which the dimming control signal V_{DIM} is lower than the first level, the driving current I_{LED} is small, and accordingly, the current Ii is also small. This leads to a reduced voltage drop V_{Ri} across the detection resistor Ri, resulting in increased probability of false detection of the overcurrent state due to noise. In order to solve such a problem, in such a range in which the dimming control signal V_{DIM} is lower than the first value, the threshold voltage V_{THi} is clamped at a predetermined lower level, thereby preventing false detection of the overcurrent state due to noise.

At least one from among the M threshold voltages may be set (i-1) such that it is increased according to the dimming control signal in a range in which the dimming control signal is higher than the first value and is lower than the second value, and (i-2) such that it is set to a predetermined upper limit value in a range in which the dimming control signal is higher than the second value.

If the threshold voltage V_{THi} is raised according to an increase in the target value of the driving current I_{LED} without limitation, when the target value is set to an extremely large value, such an arrangement does not prevent an extremely large current from flowing through a path to be protected. With the present embodiment, in a range in which the dimming control signal V_{DIM} is higher than the second value, the threshold voltage V_{THi}, i.e., the threshold current I_{THi}, is clamped at a predetermined upper limit level. Thus, such an arrangement limits the current such that it does not exceed the predetermined upper limit level. As a result, such an arrangement facilitates the selection of the components of the circuit.

Also, one of the M detection resistors may correspond to a third detection resistor configured as a built-in component of the current driver and arranged on a path of the driving current.

Also, one of the aforementioned M detection resistors may correspond to the second detection resistor arranged on a path of the switching transistor.

Also, one of the M detection resistors may correspond to a third detection resistor configured as a built-in component of the current driver and arranged on a path of the driving current. Also, another one of the aforementioned M detection resistors may correspond to the second detection resistor arranged on a path of the switching transistor.

Also, the voltage source may be configured to receive an instruction signal which indicates the target luminance level of the light emitting element, to generate the dimming control signal in proportion to the instruction signal, and to generate at least one of the M threshold voltages according to the instruction signal.

Also, the voltage source may be configured to be switchable between multiple modes. Also, at least one from among relations between the dimming control signal and each of the M threshold voltages may be changed according to mode switching.

With such an arrangement, the optimum mode is selected according to the state of the light emitting apparatus or according to the platform on which the light emitting apparatus is employed. Thus, such an arrangement is capable of performing the optimum overcurrent protection with reduced power consumption.

Also, the multiple modes may include a constant threshold mode in which at least one from among the M threshold voltages is fixed to a constant level regardless of the dimming control signal.

Also, the voltage source may be set to the constant threshold mode in a startup operation of the light emitting apparatus, following which the voltage source transits to another mode.

Immediately after the startup operation, the output voltage of the switching power supply is low. In this state, the duty ratio of the gate pulse signal, i.e., the on time of the switching transistor, is increased. As a result, the current that flows through the switching transistor or the inductor in the startup operation is large as compared with that in the normal operation state. In a case in which the constant threshold mode is not selected, when the dimming control signal level is reduced, the threshold current is also reduced. In this state, the current that flows through the switching transistor or the inductor is controlled according to such a small threshold current. In some cases, this leads to an increased startup time. With the present embodiment, the constant threshold mode is selected in the startup state. Thus, such an arrangement does not impose an unnecessary limitation on the current that flows through the switching transistor or the inductor. This allows the light emitting apparatus to start up in a short period of time.

Also, the light emitting element may be configured as an LED string comprising multiple light emitting diodes connected in series.

Yet another embodiment of the present invention relates to a light emitting apparatus. The light emitting apparatus comprises: a light emitting element; and a switching power supply configured to supply a driving voltage to one end of the light emitting element. The switching power supply comprises: a switching transistor; and the aforementioned control circuit configured to switch on and off the switching transistor.

Yet another embodiment of the present invention relates to an electronic device. The electronic device comprises: a liquid crystal panel; and the aforementioned light emitting apparatus arranged as a backlight of the liquid crystal panel.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing an example configuration of a light emitting apparatus according to a comparison technique;

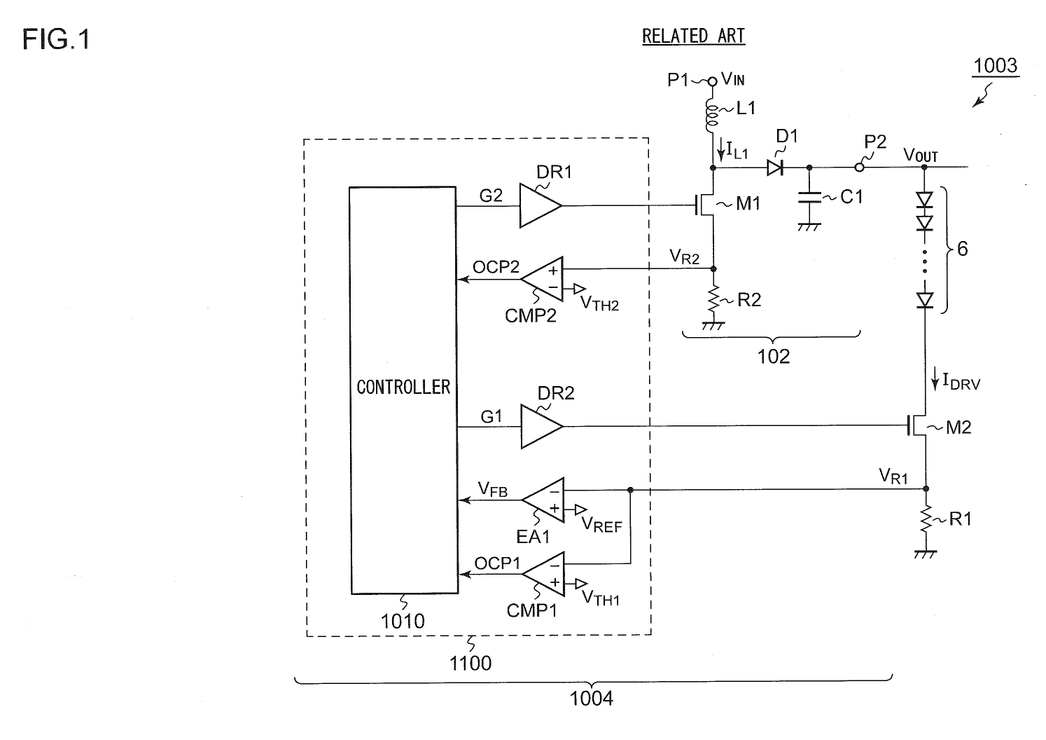

FIG. 2 is a circuit diagram showing a light emitting apparatus including a control circuit according to a first embodiment of the present invention;

FIGS. 3A through 3C are circuit diagrams each showing an example configuration of a pulse width modulator;

FIG. 4A is a graph showing the relation between the dimming control signal V_{DIM} and the threshold voltage V_{TH}, and FIG. 4B is a graph showing the relation between the dimming instruction signal V_{DIM*} and the threshold voltage V_{TH};

FIGS. 5A and 5B are circuit diagrams each showing an example configuration of a voltage source;

FIG. 6 is a graph showing the relations between the dimming control signal V_{DIM} and each of the threshold voltages V_{TH1} and V_{TH2} in the constant threshold mode and the variable threshold mode;

FIG. 7 is a circuit diagram showing a light emitting apparatus including a control circuit according to a second embodiment of the present invention;

FIG. 8 is a diagram showing an example of an electronic device including a light emitting apparatus;

FIGS. 9A and 9B are circuit diagrams each showing another example configuration of an output circuit of a switching power supply;

FIG. 10 is a circuit diagram showing a part of a control circuit according to a second modification; and

FIG. 11 is a circuit diagram showing an example configuration of a generating circuit which generates the dimming control signal V_{DIM}.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

### First Embodiment

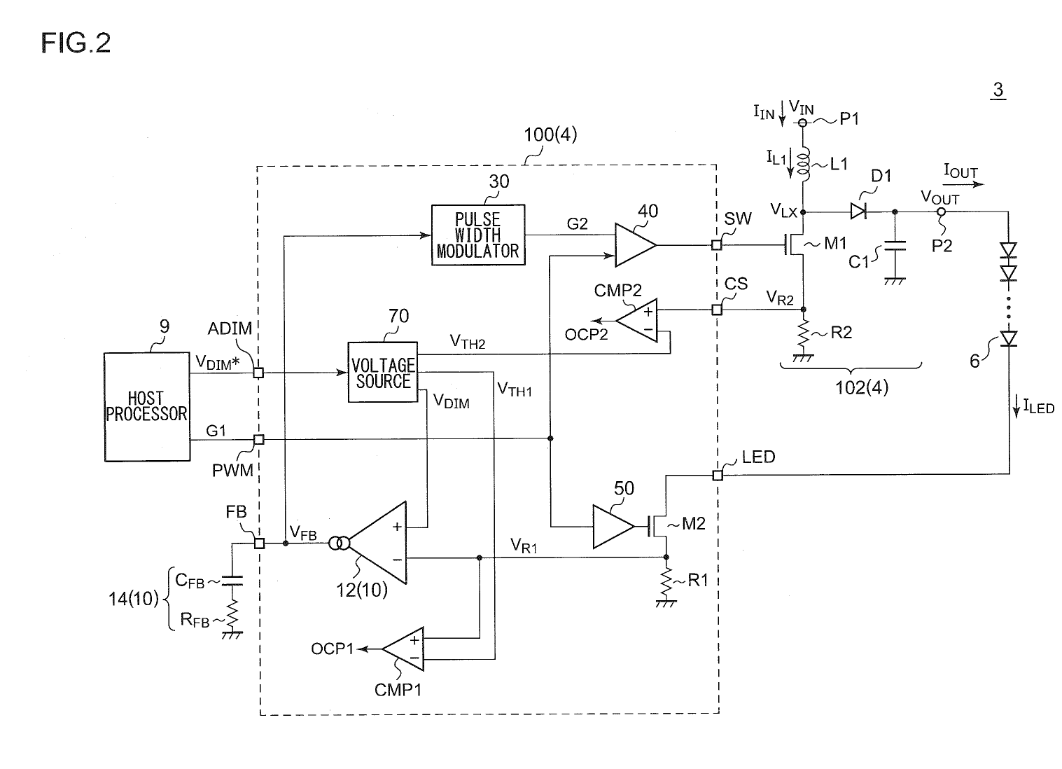

FIG. 2 is a circuit diagram showing a light emitting apparatus including a control circuit according to a first embodiment of the present invention. A light emitting apparatus 3 includes a light emitting element 6, a switching power supply 4, and a host processor 9.

The light emitting element 6 is an LED string including multiple LEDs connected in series. One end (anode) of each light emitting element 6 is connected in common to an output terminal P2 of the switching power supply 4.

The host processor 9 integrally controls the overall operation of the light emitting apparatus 3. Specifically, the host processor 9 generates a dimming instruction signal V_{DIM*} having a voltage level that corresponds to the target luminance level of the light emitting element 6, and transmits the dimming instruction signal V_{DIM*} thus generated to a control circuit 100. The dimming instruction signal V_{DIM*} may be an analog voltage, a digital signal, the duty ratio of a pulse signal, the frequency of a pulse signal, or the like. Alternatively, the dimming instruction signal V_{DIM*} may be a circuit constant such as a resistance value of an external resistor.

The switching power supply 4 is a step-up DC/DC converter. The switching power supply 4 steps up the input voltage V_{IN} input to its input terminal P1, and supplies the driving voltage V_{OUT} to one end (anode) of the light emitting element 6 connected to its output terminal P2.

The switching power supply 4 includes a control circuit 100 and an output circuit 102. The control circuit 102 includes an inductor L1, a rectifier diode D1, a switching transistor M1, an output capacitor C1, and a second detection resistor R2. The output circuit 102 has a typical topology, and accordingly, description thereof will be omitted.

A switching terminal SW of the control circuit 100 is connected to the gate of the switching transistor M1. The control circuit 100 generates a gate pulse signal G2 having a duty ratio adjusted by means of feedback control so as to obtain an output voltage V_{OUT} required to turn on the light emitting element 6, thereby controlling the switching operation of the switching transistor M1. Furthermore, the control circuit 100 adjusts a driving current I_{LED} that flows through the light emitting element 6 such that the light emitting element 6 emits light at a target luminance level.

The control circuit 100 is a function IC monolithically integrated on a single semiconductor substrate. Examples of such a “monolithically integrated” arrangement include: an arrangement in which all the circuit components are formed on a semiconductor substrate; and an arrangement in which principal circuit components are monolithically integrated. Also, a part of the circuit components such as resistors and capacitors may be arranged in the form of components external to such a semiconductor substrate in order to adjust the circuit constants. Also, the switching transistor M1 may be built into the control circuit 100.

The control circuit 100 includes, as input/output pins, a switching (SW) terminal, a current detection (CS) terminal, a burst dimming (PWM) terminal, an analog dimming (ADIM) terminal, a feedback (FB) terminal, and an LED terminal.

The dimming instruction signal V_{DIM*} is input to the ADIM terminal from the host processor 9. The SW terminal is connected to the gate of the switching transistor M1. The FB terminal is connected to a phase compensating circuit 14 including a capacitor C_{FB} and a resistor R_{FB} for phase compensation. The CS terminal receives, as an input signal, the second detection voltage V_{R2} that corresponds to a voltage drop across the second resistor R2. The LED terminal is connected to the cathode of the light emitting element 6. The control circuit 100 receives, as an input signal via the PWM terminal, the dimming pulse signal G1 for burst dimming control output from the host processor 9. The dimming pulse signal G1 is pulse width modulated according to the target luminance level of the light emitting element 6. Specifically, the dimming pulse signal G1 has a duty ratio that becomes greater as the target luminance level becomes higher.

The control circuit 100 includes an error amplifier 10, a pulse width modulator 30, a gate driver 40, a dimming driver 50, a dimming switch M2, a first detection resistor R1, a voltage source 70, a first comparator CMP1, and a second comparator CMP2.

The dimming switch M2 and the first detection resistor R1 are arranged on a path of the driving current that flows through the light emitting element 6. More specifically, the dimming switch M2 and the first detection resistor R1 are arranged in series between the LED terminal and the ground terminal. The dimming driver 50 switches on and off the dimming switch M2 according to the dimming pulse signal G1, so as to switch the driving current I_{LED} between conduction and disconnection. The dimming switch M2 and the first detection resistor R1 may each be an external component of the control circuit 100 configured as an IC.

The error amplifier 10 amplifies the difference between a first detection voltage V_{R1} that corresponds to a voltage drop across the first detection resistor R1 and a dimming control signal V_{DIM}, so as to generate a feedback voltage V_{FB}. As described later, the dimming control signal V_{DIM} has a voltage level that corresponds to the dimming instruction signal V_{DIM*}. The error amplifier 10 includes a transconductance (gm) amplifier 12 and a phase compensating circuit 14, for example. The phase compensating circuit 14 includes a capacitor C_{FB} and a resistor R_{FB} for phase compensation.

The pulse width modulator 30 generates the gate pulse signal G2. The pulse width modulator 30 adjusts the duty ratio of the gate pulse signal G2 according to at least the feedback voltage V_{FB} such that the first detection voltage V_{R1} matches the dimming control signal V_{DIM}.

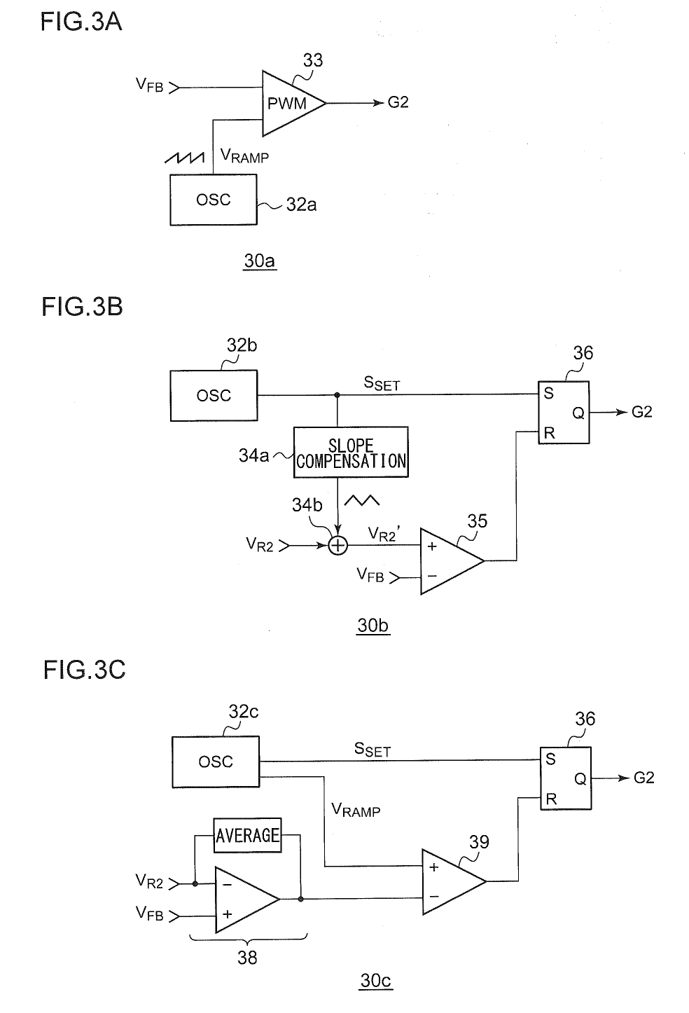

FIGS. 3A through 3C are circuit diagrams each showing an example configuration of the pulse width modulator 30. The pulse width modulators 30 shown in FIGS. 3A through 3C each include an oscillator 32. The pulse width modulator 30 generates the gate pulse signal G2 in synchronization with a cyclic signal generated by the oscillator 32.

The pulse width modulator 30a shown in FIG. 3A performs a voltage mode control operation. The pulse width modulator 30a includes an oscillator 32a and a PWM comparator 33. The oscillator 32a generates a cyclic signal (ramp voltage) V_{RAMP} having a triangle waveform or otherwise a sawtooth waveform. The PWM comparator 33 compares the feedback signal V_{FB} with the cyclic signal V_{RAMP}, so as to generate a gate pulse signal G2 that corresponds to the comparison result.

The pulse width modulator 30b shown in FIG. 3B performs a peak current mode control operation. The pulse width modulator 30b includes an oscillator 32b, a PWM comparator 33, a slope compensating circuit 34, a peak detection comparator 35, and a flip-flop 36. The pulse width modulator 30b receives, as an input signal, a voltage drop (second detection voltage) V_{R2} across the second resistor R2 according to a current that flows through the switching transistor M1.

The oscillator 32b generates a pulse-shaped cyclic signal (set signal) S_{SET}. The slope compensating circuit 34 generates a slope voltage in synchronization with the set signal S_{SET}, and superimposes the slope voltage thus generated on the current detection signal V_{R2}. The slope compensating circuit 34 may include a slope voltage generating unit 34a which generates a slope voltage, and an adder 34b which generates the sum of the slope voltage and the current detection signal V_{R2}, for example. It should be noted that the configuration of the slope compensating circuit 34 is not restricted in particular.

The peak detection comparator 35 compares the detection voltage V_{R2′} subjected to slope compensation with the feedback voltage V_{FB}, and generates a reset signal S_{RST} that corresponds to the comparison result. The flip-flop 36 generates a gate pulse signal G2 having a level which transits according to the set signal S_{SET} and the reset signal S_{RST}. For example, the flip-flop 36 may also be an SR flip-flop having a set terminal via which the set signal S_{SET} is input and having a reset terminal via which the reset signal S_{RST} is input.

The pulse width modulator 30c shown in FIG. 3C performs an average current mode control operation. The pulse width modulator 30c includes an oscillator 32c, a flip-flop 36, a current error amplifier 38, and a comparator 39. The pulse width modulator 30c receives, as an input signal, the voltage drop (detection voltage) V_{R2} across the second resistor R2 that corresponds to a current that flows through the switching transistor M1.

The oscillator 32c generates a cyclic signal (ramp voltage V_{RAMP}) having a triangle waveform or otherwise a sawtooth waveform, and a set signal S_{SET}.

The current error amplifier 38 amplifies the difference between the second detection voltage V_{R2} and the feedback voltage V_{FB}, and averages the difference thus amplified. The comparator 39 compares the output voltage V_{ERR} output from the current error amplifier 38 with the ramp signal V_{RAMP}, so as to generate the reset signal S_{RST} that corresponds to the comparison result. The flip-flop 36 generates the gate pulse signal G2 having a level which is switched according to the set signal S_{SET} and the reset signal S_{RST}.

In addition to the configurations of the pulse width modulator 30 shown in FIGS. 3A through 3C for exemplary purposes, various configurations of the pulse width modulator 30 may be made, which will be clearly understood by those skilled in this art. With the present invention, the configuration of the pulse width modulator 30 is not restricted in particular, which will be clearly understood by those skilled in this art. Furthermore, the present invention can be effectively applied to an arrangement employing another kind of pulse modulator such as a pulse frequency modulator instead of the pulse width modulator 30.

Returning to FIG. 2, during a low level period of the dimming pulse signal G1, the gate driver 40 suspends the switching of the switching transistor M1. During the high-level period of the dimming pulse signal G1, the gate driver 40 switches on and off the switching transistor M1 according to the gate pulse signal G2.

The light emitting apparatus 3 shown in FIG. 2 performs both the analog dimming control operation according to the dimming control signal V_{DIM} and the burst dimming control operation (PWM dimming control operation) according to the dimming pulse signal G1. Such an arrangement is capable of controlling the luminance level of the light emitting element 6.

Next, description will be made regarding the overcurrent protection by the light emitting apparatus 3.

The control circuit 100 includes M (M represents an integer) detection resistors, i.e., R1 and R2. Description will be made in the present embodiment regarding an arrangement in which M=2. The M detection resistors R1 and R2 are each arranged on a path of a current of the light emitting apparatus 3 to be a target of overcurrent protection. More specifically, the driving current I_{LED} is a first current to be a target of overcurrent protection. Thus, one of the M detection resistors is the first detection resistor R1 arranged on a path of the driving current I_{LED}. Furthermore, the current that flows through the switching transistor M1 is a second current to be a target of overcurrent protection. Thus, another of the M detection resistors is the second detection resistor R2 arranged on a path of the switching transistor M1. It should be noted that the current to be a target of overcurrent protection is not restricted to the aforementioned currents. Rather, a current that flows through a desired path included in the light emitting apparatus 3 may be selected as such a target current as necessary. Also, the on resistance of the switching transistor M1 may also be substituted for the second detection resistor R2.

The voltage source 70 generates M threshold voltages V_{TH1} and V_{TH2} respectively associated with the M detection resistors R1 and R2.

The M comparators CMP1 and CMP2 are arranged for the detection resistors R1 and R2, respectively. When the detection voltage that corresponds to a voltage drop V_{Ri} across the corresponding detection resistor Ri exceeds the corresponding threshold voltage V_{THi}, the i-th comparator CMPi asserts (sets to high level, for example) the overcurrent detection signal OCPi.

When at least one overcurrent detection signal OCP is asserted, the control circuit 100 executes a predetermined protection operation. Examples of such protection operations may include: a temporary suspension of the switching transistor M1; and suspension of the switching transistor M1 over an extended period of time. Alternatively, the light emitting apparatus 3 may be completely shut down. Also, the kind of overcurrent protection may be switched for each kind of overcurrent detection signal OCP.

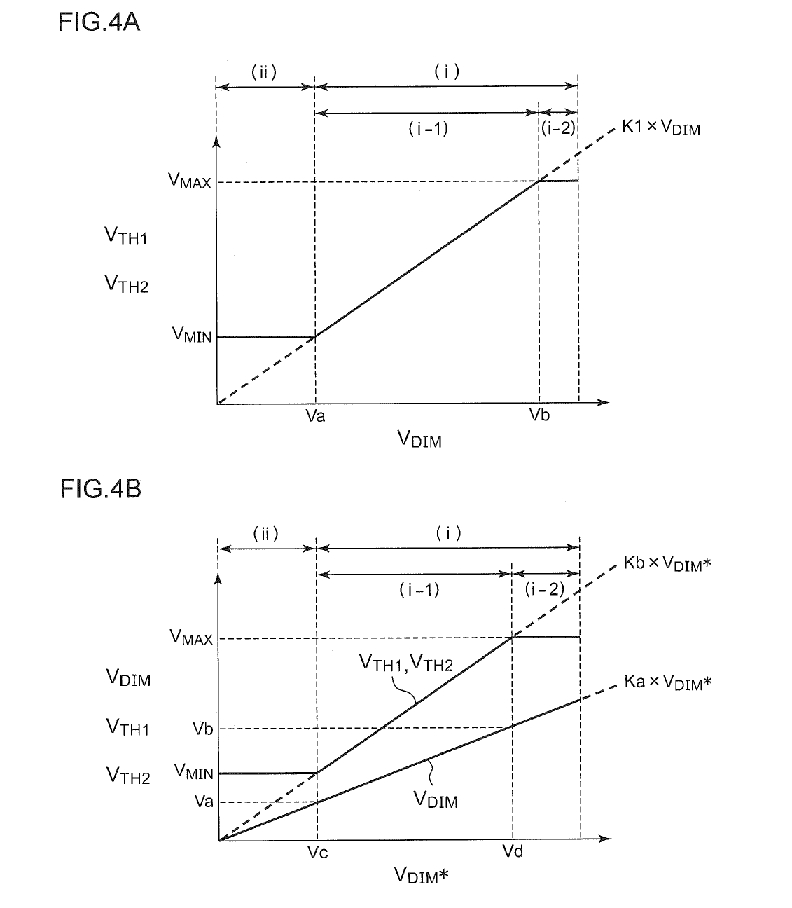

The voltage source 70 generates at least one from among the M threshold voltages V_{TH1} and V_{TH2} such that the generated voltage level corresponds to the dimming control signal V_{DIM}. FIG. 4A is a graph showing the relation between the dimming control signal V_{DIM} and the threshold voltage V_{TH}. Description will be made in the present embodiment regarding an arrangement in which both the two threshold voltages V_{TH1} and V_{TH2} are generated such that they have a level that corresponds to the dimming control signal V_{DIM}. However, the present invention is not restricted to such an arrangement. For example, either one of the threshold voltages V_{TH1} and V_{TH2} may be set to a constant value, with only the other threshold voltage adjusted according to the dimming control signal V_{DIM}.

At least one of the respective M threshold voltages V_{TH1} and V_{TH2} (both of them in the present embodiment) is generated (i) such that the threshold voltage is increased according to an increase in the dimming control signal V_{DIM}, in a range in which the dimming control signal V_{DIM} is greater than a predetermined first value Va, and (ii) such that the threshold voltage is set to a predetermined lower limit value V_{MIN}, in a range in which the dimming control signal V_{DIM} is smaller than the first value Va.

Furthermore, at least one of the respective M threshold voltages V_{TH1} and V_{TH2} (both of them in the present embodiment) is generated (i-1) such that the threshold voltage is increased according to an increase in the dimming control signal V_{DIM}, in a range in which the dimming control signal V_{DIM} is greater than the first value Va and is smaller than a predetermined second value Vb, and (i-2) such that the threshold voltage is set to a predetermined upper limit value V_{MAX}, in a range in which the dimming control signal V_{DIM} is greater than the second value Vb.

(i-1) In a range in which the dimming control signal V_{DIM} is greater than the first value Va and is smaller than the predetermined value Vb, the threshold voltages V_{TH1} and V_{TH2} may be generated in proportion to the dimming control signal V_{DIM}. In this range, the threshold voltages V_{TH1} and V_{TH2} are generated such that the following Expressions hold true.

V_{TH1}=K1×V_{DIM}

V_{TH2}=K2×V_{DIM}

FIG. 4A shows an arrangement in which K1 is equal to K2. However, the present invention is not restricted to such an arrangement. Also, an arrangement may be made in which K1 is not equal to K2.

FIG. 4A shows an arrangement in which the threshold voltages V_{TH1} and V_{TH2} are completely equal to each other. However, the present invention is not restricted to such an arrangement. Also, Va, Vb, V_{MIN}, and V_{MAX} may be set to different values for each threshold voltage.

The voltage source 70 receives the dimming instruction signal V_{DIM*}, and generates the dimming control signal V_{DIM} which is proportional to the dimming instruction signal V_{DIM*} thus received. Furthermore, the voltage source 70 generates at least one of the M threshold voltages V_{TH1} and V_{TH2} (both of them in the present embodiment) according to the dimming instruction signal V_{DIM*}. FIG. 4B is a graph showing the relation between the dimming instruction signal V_{DIM*} and the threshold voltage V_{TH}. The dimming control signal V_{DIM} is generated in proportion to the dimming instruction signal V_{DIM*}. Furthermore, when V_{DIM*}<Vc, V_{TH} is set to V_{MIN}. When Vd<V_{DIM*}, V_{TH} is set to V_{MAX}.

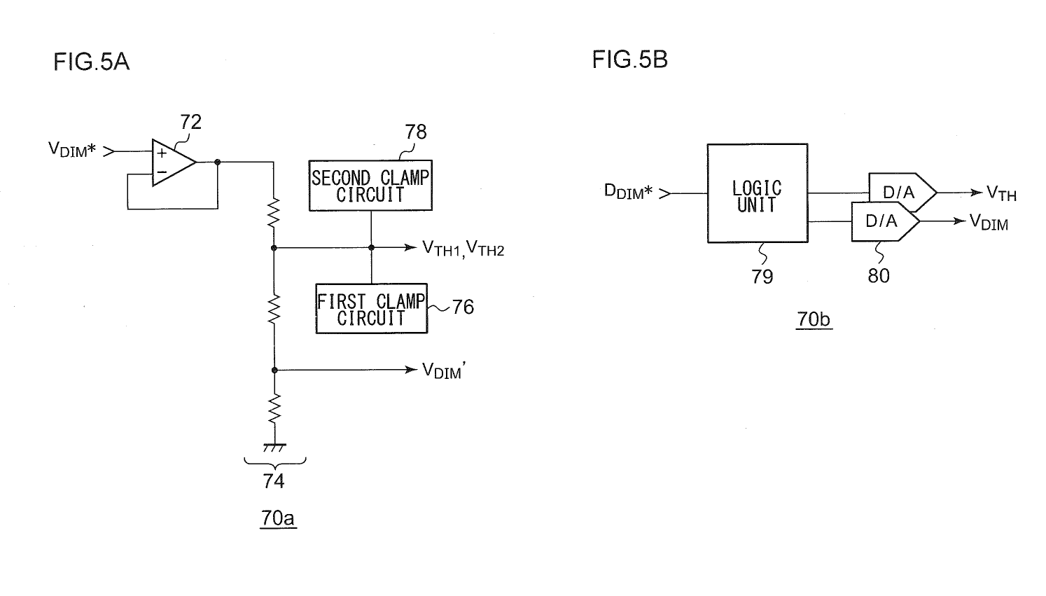

FIGS. 5A and 5B are circuit diagrams each showing an example configuration of the voltage source 70. The voltage source 70a shown in FIG. 5A includes a buffer 72, a resistor voltage dividing circuit 74, a first clamp circuit 76, and a second clamp circuit 78. The buffer 72 receives the dimming instruction signal V_{DIM*}. The resistor dividing circuit 74 includes multiple resistors connected in series. The resistor dividing circuit 74 divides the output voltage of the buffer 72 with a predetermined dividing ratio Ka, so as to generate the dimming control signal V_{DIM}. With such an arrangement, the dimming control signal V_{DIM} is generated in proportion to the dimming instruction signal V_{DIM*}.

V_{DIM}=Ka×V_{DIM*}

Furthermore, the resistor voltage dividing circuit 74 divides the output voltage of the buffer 72 with a predetermined dividing ratio Kb, so as to generate the threshold voltages V_{TH1} and V_{TH2} in proportion to the dimming instruction signal V_{DIM*}.

V_{TH1}=V_{TH2}=Kb×V_{DIM*}

The first clamp circuit 76 clamps the threshold voltages V_{TH1} and V_{TH2} such that they do not become equal to or smaller than the predetermined lower limit value V_{MIN}. The second clamp circuit 78 clamps the threshold voltages V_{TH1} and V_{TH2} such that they do not become equal to or greater than the predetermined upper limit value V_{MAX}.

Such an arrangement is capable of generating the threshold voltages V_{TH1} and V_{TH2} and the dimming control signal V_{DIM} shown in FIG. 4B. Furthermore, such an arrangement is capable of setting the slope of the range (ii-1). Moreover, such an arrangement is capable of setting the lower limit values of the threshold voltages V_{TH1} and V_{TH2} according to the lower limit voltage V_{MIN} set for the first clamp circuit 76. Moreover, such an arrangement is capable of setting the upper limit values of the threshold voltages V_{TH1} and V_{TH2} according to the upper limit voltage V_{MAX} set for the second clamp circuit 78.

It should be noted that, in a case in which the circuit which generates the dimming instruction signal V_{DIM*}, i.e., the host processor 9, has a sufficiently low impedance, the buffer 72 may be omitted.

The voltage source 70b shown in FIG. 5B includes a logic unit 79 and a D/A converter 80. The logic unit 79 receives a digital dimming instruction signal D_{DIM*}. The logic unit 79 stores tables or expressions which represent the relation between the dimming instruction signal D_{DIM*} and each of the threshold voltages V_{TH1} and V_{TH2} and the dimming control signal V_{DIM}. Furthermore, the logic unit 79 generates the threshold voltages and the dimming control signal V_{DIM} in the form of digital values according to the dimming instruction signal D_{DIM*}. The D/A converter 80 performs digital/analog conversion of the digital values, so as to generate the threshold voltages V_{TH1} and V_{TH2} and the dimming control signal V_{DIM}.

It should be noted that the configuration of the voltage source is not restricted to such configurations shown in FIGS. 5A and 5B. Also, other configurations may be employed.

Returning to FIG. 2, the voltage source 70 is preferably configured to be switchable between multiple modes. In the voltage source 70, the relation between the dimming control signal V_{DIM} and at least one of the M threshold voltages V_{TH1} and V_{TH2} (both of them in the present embodiment) is changed according to the mode switching. For example, the voltage source 70 is configured to be switchable between a constant threshold mode and one or multiple variable threshold modes.

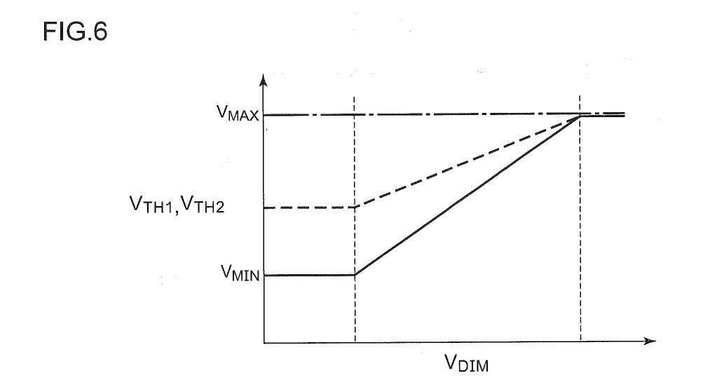

FIG. 6 is a diagram showing the relation between the dimming control signal V_{DIM} and the threshold voltages V_{TH1} and V_{TH2} in the constant threshold mode and the variable threshold mode. In the constant threshold mode, at least one of the M threshold voltages V_{TH1} and V_{TH2} (both of them in the present embodiment) is fixed to a constant level regardless of the dimming control signal V_{DIM} (line of dashes and dots). The constant level may match the upper limit value V_{MAX} used in the variable threshold mode. In the variable threshold mode, as described above, the threshold voltages V_{TH1} and V_{TH2} are each changed according to the dimming control signal V_{DIM} (solid line and broken line). Multiple variable threshold modes may be prepared.

In the startup operation of the light emitting apparatus 3, the voltage source 70 is set to the constant threshold mode. Subsequently, after the completion of the startup operation, the voltage source 70 transits to the variable threshold mode. The completion of the startup operation may be detected based on at least one of the following items, or otherwise a combination of the following items.

(i) The overcurrent detection signal is not asserted within a predetermined judgment period after the startup operation.

(ii) The first detection voltage V_{R1} reaches the dimming control signal V_{DIM}.

(iii) The driving voltage V_{OUT} reaches a predetermined threshold voltage.

(iv) A predetermined startup time elapses after the startup operation.

The above is the configuration of the light emitting apparatus 3. Next, description will be made regarding the operation thereof.

First, description will be made regarding a normal operation of the light emitting apparatus 3. The pulse width modulator 30 adjusts the duty ratio of the gate pulse signal G2 by means of feedback control such that the first detection voltage V_{R1} configured as a voltage drop across the first detection resistor R1 approaches the dimming control signal V_{DIM}. As a result, the driving current I_{LED} is stabilized to a target value (V_{DIM}/R1) which is proportional to the dimming control signal V_{DIM}.

By making a comparison with comparison techniques, the advantages of the light emitting apparatus 3 can be clearly understood. With such comparison techniques, the level of the threshold voltage V_{TH} is determined regardless of the target value of the driving current I_{LED}. That is to say, a constant threshold current I_{TH} (e.g., 200 mA) is set. Thus, in a case in which the target value of the driving current I_{LED} is set to a small value, e.g., 20 mA, the protection operation is not performed before the current that flows through the light emitting element 6 reaches 200 mA. In this state, such an operation results in wasted current consumption.

In contrast, with the present embodiment, the threshold voltage V_{TH1} is changed according to the dimming control signal V_{DIM} in a range in which Va<V_{DIM}<Vb, as shown in FIG. 4A. Thus, the threshold current I_{TH1} (=V_{TH1}/R1) is changed according to the dimming control signal V_{DIM}.

For example, in a case in which K=1.5, when the target value of the driving current I_{LED} is set to 20 mA, the threshold current I_{TH1} is set to 30 mA. With such an arrangement, protection is performed such that the current value does not become equal to or greater than 30 mA. That is to say, such an arrangement is capable of providing a reduction in current consumption of 170 mA, as compared with conventional techniques.

Furthermore, in a range in which the dimming control signal V_{DIM} is lower than the first level Va, the driving current I_{LED} is small. In this state, the voltage drop V_{R1} across the first detection resistor R1 is also small. If the first threshold voltage V_{TH1} is generated in proportion to the dimming control signal V_{DIM} in the range V_{DIM}<Va as indicated by the broken line in FIG. 4A, this leads to a small difference between the first detection voltage V_{R1} and the first threshold voltage V_{TH1} in the non-overcurrent state (normal state). This leads to an increase in the probability of false detection of the overcurrent state due to noise.

In contrast, with the present embodiment, the first threshold voltage V_{TH1} is clamped at a predetermined lower limit level V_{MIN} in a range in which the dimming control signal V_{DIM} is lower than the first value Va. Thus, such an arrangement prevents false detection of the overcurrent state due to noise.

Instead of clamping the first threshold voltage V_{TH1} in the range in which Vb<V_{DIM}, if the first threshold voltage V_{TH1} is allowed to increase without limitation according to an increase in the dimming control signal V_{DIM}, as indicated by the broken line in FIG. 4A, in some cases, the threshold current I_{TH} becomes very large. This leads to a risk of an extremely large amount of current flowing through a path to be protected.

In contrast, with the present embodiment, the first threshold voltage V_{TH1}, i.e., the threshold current I_{TH1}, is clamped at a given upper level in a range in which the dimming control signal V_{DIM} is higher than the second value Vb. Thus, the driving current I_{LED} is limited at a given upper limit level. As a result, with such an arrangement, it becomes easier to select the components of the circuit.

In the same way, by means of the second comparator CMP2 and the second detection resistor R2, such an arrangement performs overcurrent protection for the current that flows through the switching transistor M1, thereby providing the same advantages.

Next, description will be made regarding the startup operation of the light emitting apparatus 3.

In the startup operation, in some cases, the dimming instruction signal V_{DIM*} is set to a very low level. Immediately after the startup operation, the output voltage of the switching power supply is low. In this state, the duty ratio of the gate pulse signal, i.e., the on time of the switching transistor, is set to a large value. Thus, the current that flows through the switching transistor or the inductor in the startup operation is greater than that in the normal operation.

Let us consider a situation in which the dimming control signal is set to a low level in the startup operation. In this situation, when the variable threshold mode is employed, the threshold current values I_{TH1} and I_{TH2} are each set to a small value. In this case, the current that flows through the switching transistor or the inductor is limited by the threshold current value I_{TH2}. In some cases, such an arrangement leads to a disadvantage of an increased startup time.

In contrast, with the present embodiment, the constant threshold mode is selected in the startup operation. Thus, such an arrangement does not impose an unnecessary limitation on the current that flows through the switching transistor or the inductor. Thus, such an arrangement allows the light emitting apparatus to start up in a short period of time.

### Second Embodiment

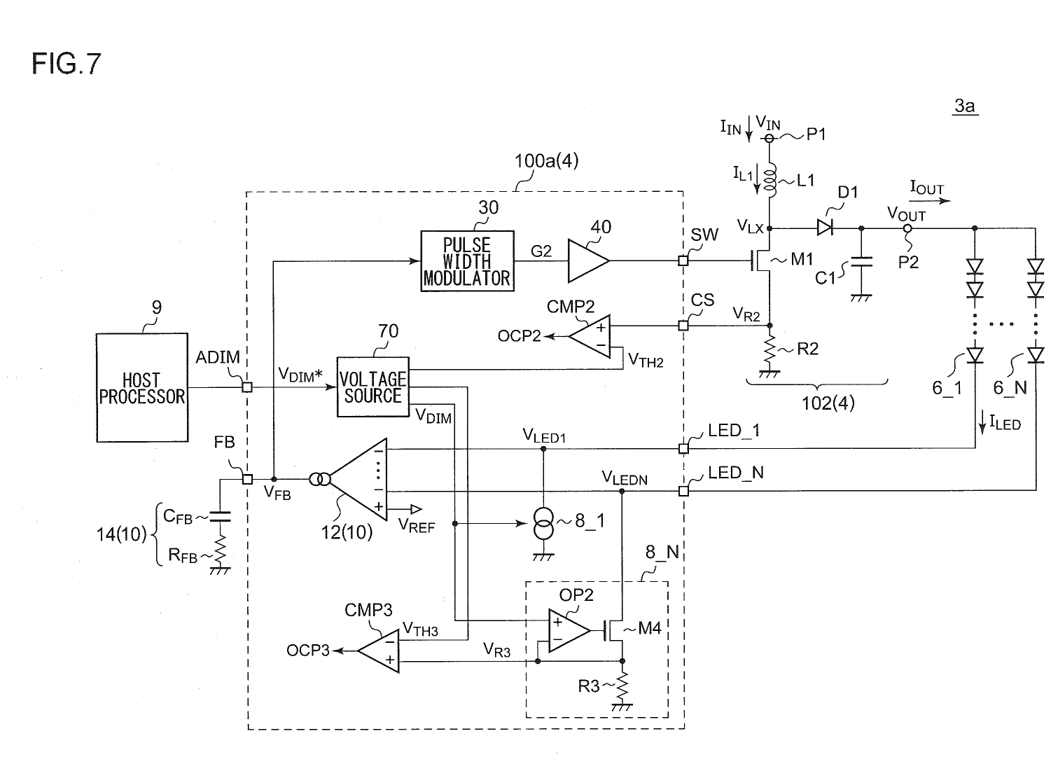

FIG. 7 is a circuit diagram showing a light emitting apparatus including a control circuit according to a second embodiment of the present invention. A light emitting apparatus 3a shown in FIG. 7 includes multiple light emitting elements 6_1 through 6_N (N represents an integer), a switching power supply 4, and a host processor 9.

The respective light emitting elements 61 through 6_N are each configured as an LED string including multiple LEDs connected in series. The number of LED strings is not restricted in particular. One end (anode) of each of the light emitting elements 6_1 through 6_N is connected in common to the output terminal P2 of the switching power supply 4.

The control circuit 100 includes, as input/output pins, a switching (SW) terminal, a current detection (CS) terminal, an analog dimming (ADIM) terminal, a feedback (FE) terminal, and N LED terminals. The N LED terminals are respectively connected to the cathodes of the light emitting elements 6_1 through 6_N.

A control circuit 100a includes current drivers 8_1 through 8_N, an error amplifier 10, a pulse width modulator 30, a gate driver 40, a voltage source 70, a second comparator CMP2, and a third comparator CMP3.

The current drivers 8_1 through 8_N are provided to the light emitting elements 6_1 through 6_N, respectively. The current driver 8_{—}i is arranged on a path of the corresponding light emitting element 6_{—}i. Specifically, the current driver 8_{—}i is arranged between one end (cathode) of the light emitting element 6_{—}i and the ground terminal. The current driver 8_{—}i generates a driving current I_{LEDi} that corresponds to the dimming control signal V_{DIM}.

The current drivers 8 each include a transistor M4, a third detection resistor R3, and an operational amplifier OP2. The transistor M4 and the third detection resistor R3 are arranged on a path of the driving current I_{LED}. Specifically, the transistor M4 and the third detection resistor R3 are sequentially arranged in series between the LED terminal and the ground terminal. The output terminal of the operational amplifier OA2 is connected to the control terminal (gate) of the transistor M4. The operational amplifier OA2 is arranged such that the dimming control signal V_{DIM} is input to its non-inverting input terminal, and such that a third detection voltage V_{R3} that corresponds to the voltage drop across the third detection resistor R3 is input to its inverting input terminal. The current driver 8_{—}i performs a feedback control operation such that the third detection voltage V_{R3} matches the dimming control signal V_{DIM}. Thus, the driving current I_{LEDi} is stabilized to the target value V_{DIM}/R3.

The error amplifier 10 amplifies the difference between a predetermined reference voltage V_{REF} and the lowest of the voltage drops across the respective current drivers 8_1 through 8_N, i.e., the lowest of the voltages V_{LED1} through V_{LEDN} at the respective LED terminals, so as to generate the feedback voltage V_{FB}.

The pulse width modulator 30 adjusts the duty ratio of the gate pulse signal G2 according to at least the feedback voltage V_{FB} such that the lowest of the voltages V_{LED1} through V_{LEDN} at the respective LED terminals matches the reference voltage V_{REF}.

In the second embodiment, one of the aforementioned M detection resistors corresponds to the third detection resistor R3 built into the current driver 8. The third comparator CMP3 compares the third detection voltage V_{R3} that develops at the third detection resistor R3 with the third threshold voltage V_{TH3} generated by the voltage source 70. When V_{R3}>V_{TH3}, the third comparator CMP3 asserts a third overcurrent detection signal OCP3. The third comparator CMP3 may be provided to each of the current drivers 8.

The above is the configuration of the light emitting apparatus 3a shown in FIG. 7.

With the light emitting apparatus 3a, the third detection resistor R3 is arranged on a path of the driving current I_{LED}. By means of the third detection resistor R3 and the third comparator CMP3, an overcurrent state of the driving current I_{LED} is detected. That is to say, the third detection resistor R3 corresponds to the first detection resistor R1 in the first embodiment.

The second embodiment provides the same advantages as those provided by the first embodiment. It should be noted that the control circuit 100a shown in FIG. 7 may perform a PWM dimming control operation in addition to the analog dimming control operation. In this case, the transistor M4 included in the current driver 8 is configured to be switchable according to the dimming pulse signal G1.

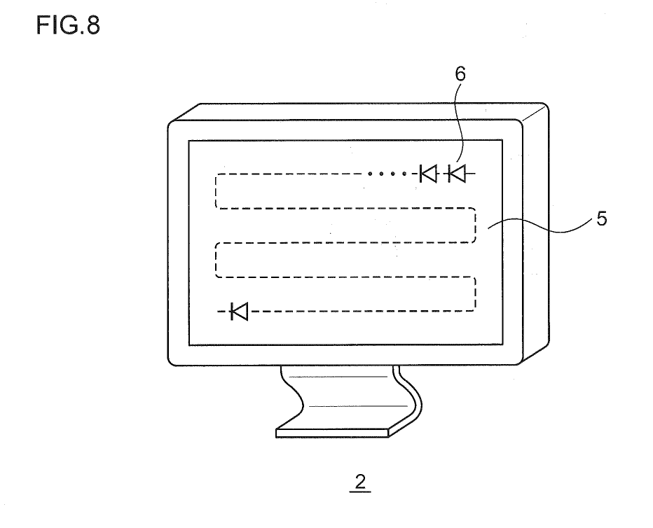

Next, description will be made regarding the usage of the light emitting apparatus 3. FIG. 8 is a diagram showing an example of an electronic device 2 including the light emitting apparatus 3. Examples of such electronic devices 2 include liquid crystal display apparatuses, TV receivers, and car navigation system display monitors, or otherwise cellular phone terminals, tablet PCs, audio players, and the like, including a liquid crystal panel.

The electronic device 2 includes an LCD (Liquid Crystal Display) panel 5. The light emitting element 6 of the light emitting apparatus 3 is arranged as a backlight on the back face of the LCD panel 5. The switching power supply 4, the current driver 8, and the host processor 9, which are not shown, are built into the casing of the electronic device 2.

Description has been made with reference to the embodiments regarding the present invention. The above-described embodiments have been described for exemplary purposes only, and are by no means intended to be interpreted restrictively. Rather, various modifications may be made by making various combinations of the aforementioned components or processes. Description will be made below regarding such modifications.

### [First Modification]

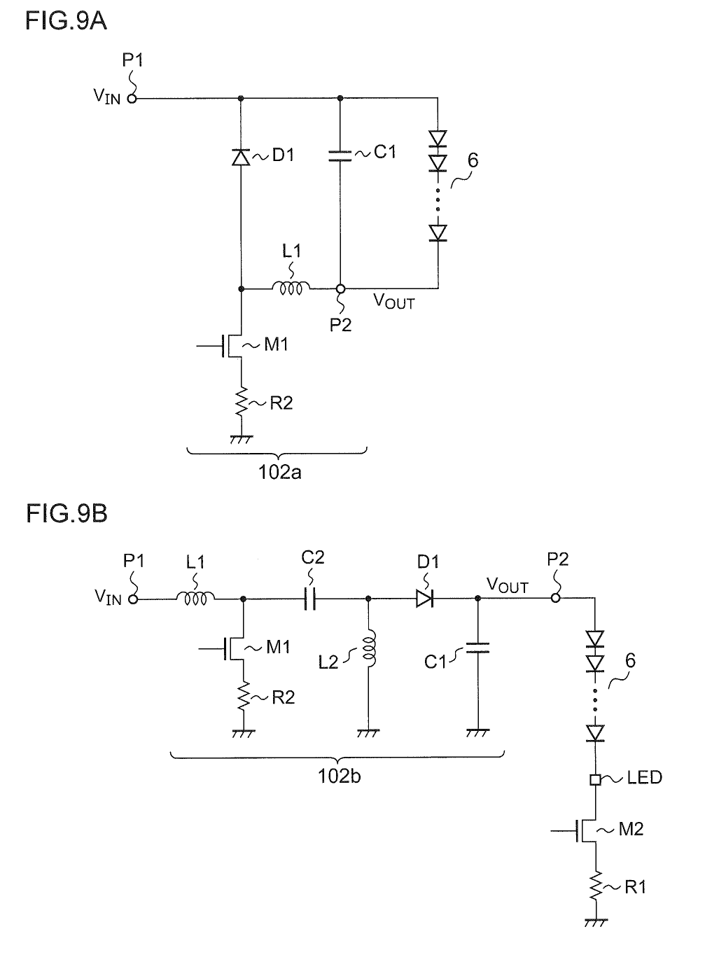

Description has been made regarding a non-insulated switching power supply employing the inductor L1. Also, the present invention is applicable to an insulated switching power supply employing a transformer. Also, the present invention is applicable to any one of a step-up switching power supply, a step-down switching power supply, and a step-up/step-down switching power supply. FIGS. 9A and 9B are circuit diagrams each showing another example configuration of the output circuit 102 of the switching power supply. An output circuit 102a shown in FIG. 9A has a step-down topology, and includes a rectifier diode D1, an inductor L1, an output capacitor C1, a switching transistor M1, and a second resistor R2. An output circuit 102b shown in FIG. 9B has a step-up/step-down topology, and includes a rectifier diode D1, capacitors C1 and C2, inductors L1 and L2, a switching transistor M1, and a second resistor R2.

### [Second Modification]

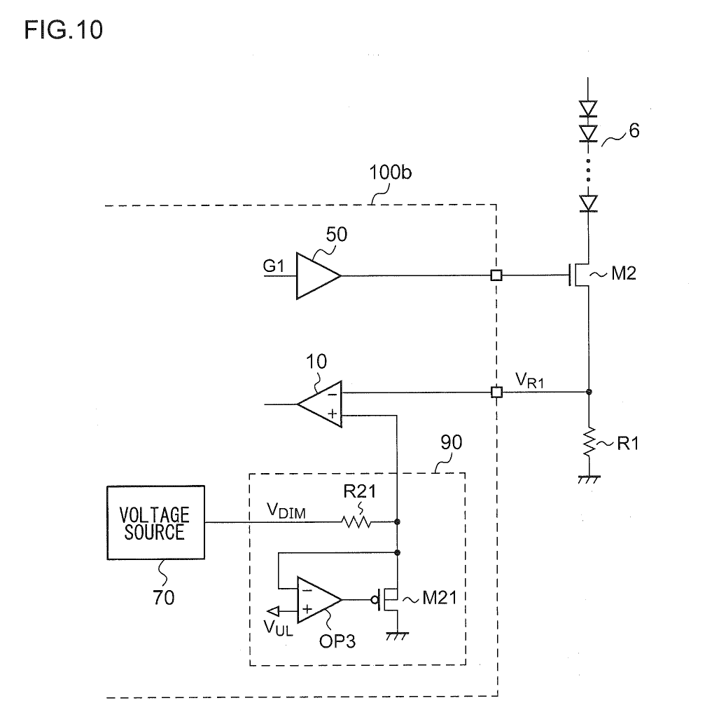

FIG. 10 is a circuit diagram showing a part of a control circuit 100b according to a second modification. The second modification is a modification of the control circuit 100 shown in FIG. 2. A dimming switch M2 and a second detection resistor R2 are provided to the control circuit 100b as external components.

The control circuit 100b includes a clamp circuit 90 which clamps the dimming control signal V_{DIM} generated by the voltage source 70 such that it does not exceed a predetermined level V_{UL}. By providing such a clamp circuit 90, such an arrangement is capable of preventing a large current from flowing through the light emitting element 6.

The configuration of the clamp circuit 90 is not restricted in particular. The clamp circuit 90 includes a transistor M21, a resistor R21, and an operational amplifier OP3, for example. The resistor R21 is arranged between the inverting input terminal of the error amplifier 10 and the voltage source 70. The transistor M21 is a P-channel MOSFET, and is arranged between the ground terminal and the non-inverting input terminal of the error amplifier 10. The predetermined level V_{UL} is input to the non-inverting input terminal of the operational amplifier OP3, and its inverting input terminal is connected to the non-inverting input terminal of the error amplifier 10. The clamp circuit 90 is capable of clamping the dimming control signal V_{DIM} input to the non-inverting input terminal of the error amplifier 10 such that it does not exceed the predetermined level V_{UL}.

### [Third Modification]

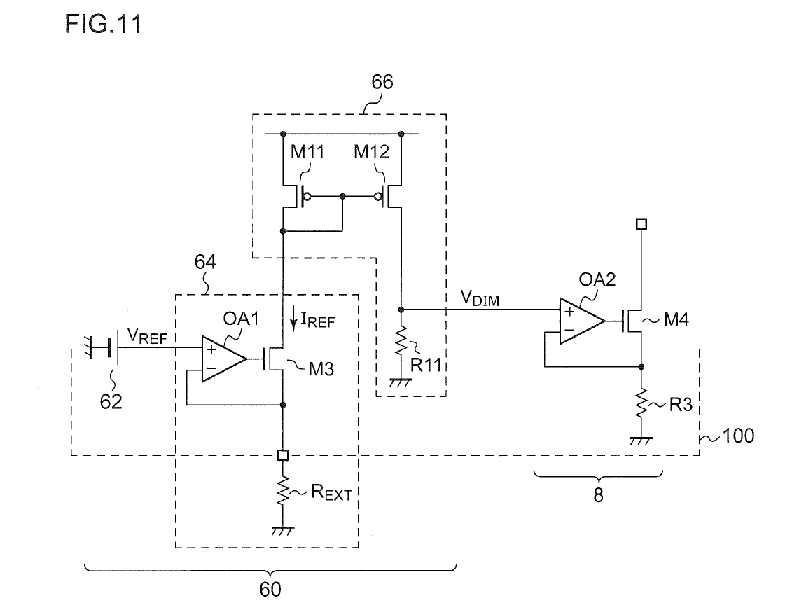

Description has been made in the embodiment regarding an arrangement in which the dimming instruction signal V_{DIM*} is supplied from the host processor 9 in the form of an analog voltage. However, the present invention is not restricted to such an arrangement. Also, the internal circuit of the control circuit 100 may generate the dimming instruction signal V_{DIM*} or otherwise the dimming control signal V_{DIM}. FIG. 11 is a circuit diagram showing an example configuration of a generating circuit which generates the dimming control signal V_{DIM}. The generating circuit 60 includes a reference voltage source 62, a V/I conversion circuit 64, and an I/V conversion circuit 66.

The reference voltage source 62 generates a reference voltage V_{REF}. The V/I conversion circuit 64 converts the reference voltage V_{REF} into a reference current I_{REF}. The V/I conversion circuit 64 is configured such that its conversion gain is switchable. More specifically, such an arrangement allows the V/I conversion gain to be changed according to an external resistor R_{EXT} of the control circuit 100. The V/I conversion circuit 64 further includes an operational amplifier OA1 and a transistor M3, in addition to the external resistor R_{EXT}. The V/I conversion circuit 64 generates the reference current I_{REF}.

I_{REF}=V_{REF}/R_{EXT}

The I/V conversion circuit 66 converts the reference current I_{REF} into the dimming control signal V_{DIM}. The I/V conversion circuit 66 includes a pair of transistors M11 and M12 that form a current mirror circuit, and a resistor R11. The current mirror circuit formed of the transistors M11 and M12 duplicates the reference current I_{REF}. The resistor R11 is arranged on a path of the reference current I_{REF′} thus duplicated. Furthermore, one end of the resistor R11 is grounded such that the electric potential thereof is fixed. With the mirror ratio of the current mirror circuit as K, the dimming control signal V_{DIM} is represented by the following Expression. Thus, it can be clearly understood that the voltage level of the dimming control signal V_{DIM} can be adjusted according to the resistance value of the external resistor R_{EXT}.

$$\begin{matrix}{V}_{DIM} = {I}_{{REF}^{′}} \times R 11 \\ = K \times {I}_{REF} \times R 11 \\ = K \times {V}_{REF} / {R}_{EXT} \times R 11\end{matrix}$$

### [Fourth Modification]

The light emitting element 6 is not restricted to such an LED string. Rather, various kinds of known or prospectively available light emitting elements may be employed.

### [Fifth Modification]

Description has been made in the embodiment regarding an arrangement in which the light emitting apparatus 3 is employed as a backlight of a liquid crystal panel. However, the present invention is not restricted to such an arrangement. For example, the light emitting apparatus 3 is applicable to illumination devices.

The settings of the signals, such as the high-level state and the low-level state of the signals, have been described in the present embodiments for exemplary purposes only. The settings can be freely modified by inverting the signals using inverters or the like.

While the preferred embodiments of the present invention have been described using specific terms, such description is for illustrative purposes only, and it is to be understood that changes and variations may be made without departing from the spirit or scope of the appended claims.

What is claimed is:

1. A control circuit used for a light emitting apparatus comprising a light emitting element and a switching power supply configured to supply a driving voltage to one end of the light emitting element, configured to control a switching transistor of the switching power supply, and to control a driving current that flows through the light emitting element, the control circuit comprising:
a first detection resistor arranged on a path of the driving current;
an error amplifier configured to amplify the difference between a first detection voltage that corresponds to a voltage drop across the first detection resistor and a dimming control signal having a level that corresponds to a target luminance level of the light emitting element, so as to generate a feedback voltage;
a pulse modulator configured to generate a gate pulse signal having a duty ratio adjusted according to the feedback voltage;
M (M represents an integer) detection resistors each provided to a current path of the light emitting apparatus that is to be a target of overcurrent protection;
a voltage source configured to generate M threshold voltages that correspond to the respective M detection resistors; and
M comparators provided for the respective detection resistors, each of which is configured to assert an overcurrent detection signal when a detection voltage that corresponds to a voltage drop across the corresponding detection resistor exceeds a corresponding threshold voltage,
wherein at least one from among the M threshold voltages is set (i) such that it is increased according to an increase in the dimming control signal in a range in which the dimming control signal is higher than a predetermined first value, and (ii) such that it is set to a predetermined lower limit value in a range in which the dimming control signal is lower than the first value.

2. The control circuit according to claim 1, wherein at least one from among the M threshold voltages is set (i-1) such that it is increased according to the dimming control signal in a range in which the dimming control signal is higher than the first value and is lower than the second value, and (i-2) such that it is set to a predetermined upper limit value in a range in which the dimming control signal is higher than the second value.

3. The control circuit according to claim 1, wherein one of the aforementioned M detection resistors corresponds to the aforementioned first detection resistor.

4. The control circuit according to claim 1, wherein one of the aforementioned M detection resistors corresponds to the second detection resistor arranged on a path of the switching transistor.

5. The control circuit according to claim 1, wherein one of the aforementioned M detection resistors corresponds to the aforementioned first detection resistor,
and wherein another one of the aforementioned M detection resistors corresponds to the second detection resistor arranged on a path of the switching transistor.

6. A control circuit used for a light emitting apparatus comprising a light emitting element and a switching power supply configured to supply a driving voltage to one end of the light emitting element, configured to control a switching transistor of the switching power supply, and to control a driving current that flows through the light emitting element, the control circuit comprising:
a current driver configured to generate a driving current according to a dimming control signal having a level that corresponds to a target luminance level of the light emitting element, and to supply the driving current thus generated to the light emitting element;
an error amplifier configured to amplify the difference between a voltage drop across the current driver and a predetermined reference voltage, so as to generate a feedback voltage;
a pulse modulator configured to generate a gate pulse signal having a duty ratio adjusted according to the feedback voltage;
M (M represents an integer) detection resistors, each provided to a current path of the light emitting apparatus that is to be a target of overcurrent protection;
a voltage source configured to generate M threshold voltages that correspond to the respective M detection resistors; and
M comparators provided to the respective detection resistors, each of which is configured to assert an overcurrent detection signal when a detection voltage that corresponds to a voltage drop across the corresponding detection resistor exceeds a corresponding threshold voltage,
wherein at least one from among the M threshold voltages is set (i) such that it is increased according to an increase in the dimming control signal in a range in which the dimming control signal is higher than a predetermined first value, and (ii) such that it is set to a predetermined lower limit value in a range in which the dimming control signal is lower than the first value.

7. The control circuit according to claim 6, wherein at least one from among the M threshold voltages is set (i-1) such that it is increased according to the dimming control signal in a range in which the dimming control signal is higher than the first value and is lower than the second value, and (i-2) such that it is set to a predetermined upper limit value in a range in which the dimming control signal is higher than the second value.

8. The control circuit according to claim 6, wherein one of the M detection resistors corresponds to a third detection resistor configured as a built-in component of the current driver and arranged on a path of the driving current.

9. The control circuit according to claim 6, wherein one of the aforementioned M detection resistors corresponds to the second detection resistor arranged on a path of the switching transistor.

10. The control circuit according to claim 6, wherein one of the M detection resistors corresponds to a third detection resistor configured as a built-in component of the current driver and arranged on a path of the driving current,
and wherein another one of the aforementioned M detection resistors corresponds to the second detection resistor arranged on a path of the switching transistor.

11. The control circuit according to claim 1, wherein the voltage source is configured to receive an instruction signal which indicates the target luminance level of the light emitting element, to generate the dimming control signal in proportion to the instruction signal, and to generate at least one of the M threshold voltages according to the instruction signal.

12. The control circuit according to claim 6, wherein the voltage source is configured to receive an instruction signal which indicates the target luminance level of the light emitting element, to generate the dimming control signal in proportion to the instruction signal, and to generate at least one of the M threshold voltages according to the instruction signal.

13. The control circuit according to claim 1, wherein the voltage source is configured to be switchable between a plurality of modes,
and wherein at least one from among relations between the dimming control signal and each of the M threshold voltages is changed according to mode switching.

14. The control circuit according to claim 6, wherein the voltage source is configured to be switchable between a plurality of modes,
and wherein at least one from among relations between the dimming control signal and each of the M threshold voltages is changed according to mode switching.

15. The control circuit according to claim 12, wherein the plurality of modes include a constant threshold mode in which at least one from among the M threshold voltages is fixed to a constant level regardless of the dimming control signal.

16. The control circuit according to claim 15, wherein the voltage source is set to the constant threshold mode in a startup operation of the light emitting apparatus, following which the voltage source transits to another mode.

17. The control circuit according to claim 1, monolithically integrated on a single semiconductor substrate.

18. The control circuit according to claim 1, wherein the light emitting element is configured as an LED string comprising a plurality of light emitting diodes connected in series.

19. A light emitting apparatus comprising:
a light emitting element; and
a switching power supply configured to supply a driving voltage to one end of the light emitting element,
wherein the switching power supply comprises:
a switching transistor; and
the control circuit according to claim 1, configured to switch on and off the switching transistor.

20. An electronic device comprising:
a liquid crystal panel; and
the light emitting apparatus according to claim 19, arranged as a backlight of the liquid crystal panel.
